(19) United States
(12) Patent Application Publication
(10) Pub. No.: US 2019/0376815 A1
(43) Pub. Date: Dec. 12, 2019

(54) GEAR SELECTION APPARATUS FOR A VEHICLE AND METHOD FOR SHIFTING A VEHICLE TRANSMISSION

(71) Applicant: ZF Friedrichshafen AG, Friedrichshafen (DE)

(72) Inventor: Ralf Pfeifer, Diepholz (DE)

(73) Assignee: ZF Friedrichshafen AG, Friedrichshafen (DE)

(21) Appl. No.: 16/488,319

(22) PCT Filed: Jan. 22, 2018
(86) PCT No.: PCT/EP2018/051433

§ 371 Date: Aug. 23, 2019

(30) Foreign Application Priority Data
Feb. 24, 2017 (DE) 102017203013.5

(51) Int. Cl. G01D 5/14; F16H 59/10

(52) U.S. Cl. CPC G01D 5/145; H01C 1/148; F16H 59/105

(57) ABSTRACT

A gear selection apparatus for a vehicle may include a first contact strip and a second contact strip. The first contact strip may include a plurality of low level contact surfaces and a plurality of high level contact surfaces, where the low level contact surfaces are configured to connect to a low level connection for applying a low voltage level, and where the high level contact surfaces are configured to connect to a high level connection for applying a high voltage level. The second contact strip may include a plurality of signal contact surfaces, where the signal contact surfaces are configured to connect to at least six signal connections for tapping a signal combination.

### RELATED APPLICATIONS

This application is a filing under 35 U.S.C. § 371 of International Patent Application PCT/EP2018/051433, filed Jan. 22, 2018, and claiming priority to German Patent Application 10 2017 203 013.5, filed Feb. 24, 2017. All applications listed in this paragraph are hereby incorporated by reference in their entireties.

### TECHNICAL FIELD

The present invention relates to a gear selection apparatus for a vehicle, a method for shifting a vehicle transmission, a corresponding control device, and a corresponding computer program.

### BACKGROUND

The position of the gearshift lever for shifting a vehicle transmission can be determined via the detection of a magnet by means of Hall sensors. Certain spacings between Hall sensors are necessary for the position of the gearshift lever to be determined reliably.

Based on this, the present invention results in an improved gear selection apparatus and an improved method for shifting a vehicle transmission.

### BRIEF DESCRIPTION OF THE DRAWINGS

The present embodiments shall be explained in greater detail with reference to the attached drawings. Therein:

FIG. 1 shows a schematic illustration of a gear selection apparatus according to an exemplary embodiment.

FIG. 2 shows a schematic illustration of a gear selection apparatus according to an exemplary embodiment.

FIG. 3 shows a schematic illustration of the gear selection apparatus in FIG. 2.

FIG. 4 shows a schematic illustration of an interconnection of contact surfaces in a gear selection apparatus according to an exemplary embodiment.

FIG. 5 shows a schematic illustration of the electrical connections in the gear selection apparatus in FIG. 4, in a position F2.

FIG. 6 shows a schematic illustration of the electrical connections in the gear selection apparatus in FIG. 4, in a position F1.

FIG. 7 shows a schematic illustration of the electrical connections in the gear selection apparatus in FIG. 4, in a position 0.

FIG. 8 shows a schematic illustration of the electrical connections in the gear selection apparatus in FIG. 4, in a position R1.

FIG. 9 shows a schematic illustration of the electrical connections in the gear selection apparatus in FIG. 4, in a position R2.

FIG. 10 shows a flow chart for a method according to an exemplary embodiment.

FIG. 11 shows a schematic illustration of a control device according to an exemplary embodiment.

### DETAILED DESCRIPTION

A gear selection apparatus for a vehicle is presented herein, wherein the gear selection apparatus comprises some or all of the following features:

a first contact strip comprising numerous low level contact surfaces and high level contact surfaces, wherein each of the low level contact surfaces can be or are connected to a low level connection for applying a low voltage level, and each of the high level contact surfaces can be or are connected to a high level connection for applying a high voltage level;

a second contact strip comprising numerous signal contact surfaces, wherein the signal contact surfaces can be or are connected to at least six signal connections for tapping a signal combination comprised of at least six signals representing the low voltage levels and/or the high voltage levels; and

a gearshift lever with a slider that can be slid along the first contact strip and the second contact strip between numerous positions by actuating the gearshift lever, wherein the slider is configured to electrically connect each contact surface of the first contact strip to a signal contact surface in order to generate each of the six signals in each position of the gearshift lever.

A contact surface of the first or second contact strip can be, e.g., a pad in a printed circuit board or some other electrical contact surface. The high voltage levels and low voltage levels can be different levels of a supply voltage. Alternatively, the two voltage levels can be levels deviating from the supply voltage or a ground potential.

By way of example, at least one of the six signal connections can be electrically connected to at least two of the signal contact surfaces.

The gearshift lever can be shifted between at least five positions, in particular set point positions. A slider is an element connected to the gearshift lever that can be slid, which has numerous contact elements, e.g. in the form of sliding contacts. In particular, the number of contact elements can be the same as the number of signals that are to be generated. The slider can be configured, e.g., to electrically connect six contact surfaces of the first contact strip to six contact surfaces in pairs in each position of the gearshift lever, such that at total of six signals are generated in each position. This can take place, e.g., in that in each of the positions, a signal combination is generated, comprising three of the low level signals representing the low voltage levels and three of the high level signals representing the high voltage levels. In particular, the signal combinations can differ from one another when the low and high level contact surfaces are arranged in different sequences, and when the signal contact surfaces are connected to the six signal connections accordingly, from one position to another, with a Hamming spacing of at least two.

The approach described herein is based on the knowledge that a position of a gearshift lever can be determined using a slider coupled to the gearshift lever, and two contact strips that can be electrically connected to one another, each comprising numerous contact surfaces that can be subjected to different voltage levels. By appropriately selecting a sequence of the contact surfaces, and with an appropriate structure of the slider, a different signal combination comprising at least six voltage signals is generated in each position of the gearshift lever, wherein the signal combinations can differ from one another in at least two signals. In particular, each of the signal combinations can be composed of three signals representing a low voltage level and three signals representing a high voltage level.

The approach presented herein thus results in an inexpensive, particularly compact, gear selection apparatus, by means of which a reliable detection of numerous gearshift lever positions, e.g. at least five gearshift lever positions, can be ensured, even in vehicles with extremely limited installation space.

According to one embodiment, the slider can be configured to connect the low level contact surfaces, and/or the high level contact surfaces with the signal contact surfaces such that at least three low level signals representing the low voltage level, and at least three of the high level signals representing the high voltage level, in particular the same number of low level signals and high level signals, are generated in each gearshift lever position. As a result, a highly reliable detection of the gearshift lever position can be ensured with relatively simple circuitry. In particular, there must always be three signals that exhibit a high voltage level, and three that exhibit a low voltage level, thus allowing for an additional diagnosis, and always resulting in a uniform load to the current flow carrying the signals.

According to another embodiment, a total number of the low level contact surfaces and the high level contact surfaces can be the same as the total number of signal contact surfaces. As a result, the gear selection apparatus can be very compact.

In particular, it is advantageous when the first contact strip has a total of at least 13 low level contact surfaces and high level contact surfaces. Additionally or alternatively, the second contact strip can have a total of at least 13 signal contact surfaces. With this embodiment, the gear selection apparatus can be obtained with a simple circuitry.

Moreover, the low level contact surfaces, hereinafter indicated with the letter “L,” and the high level contact surfaces, hereinafter indicated with the letter “H,” can be arranged adjacently to one another in one of the following sequences:
LLLHHHHHHLLLL,
LLHHHLHHLLLHL,
LHLHLHHLHLHLL,
LHHHLLHLLLHHL,
HLLLHHLHHHLLH,
HLHLHLLHLHLHH,
HHLLLHLLHHHLH,
HHHLLLLLLHHHH,

Additionally or alternatively, the signal contact surfaces can be arranged adjacently to one another in the following sequence:
S₁ S₂ S₃ S₁ S₂ S₃ S₄ S₅ S₆ S₄ S₅ S₆ S₁,

Wherein S₁ stands for a signal contact surface connected to a first signal connection, S₂ stands for a signal contact surface connected to a second signal connection, S₃ stands for a signal contact surface connected to a third signal connection, S₄ stands for a signal contact surface connected to a fourth signal connection, S₅ stands for a signal contact surface connected to a fifth signal connection, and S₆ stands for a signal contact surface connected to a sixth signal connection.

As a result, a clear distinction can be obtained between five different gearshift lever positions using contact strips, each of which has only 13 contact surfaces.

According to another embodiment, the first contact strip can contain at least one low level contact surface unit, in which at least two adjacent low level contact surfaces are combined to form a unit. Additionally or alternatively, the first contact strip can contain at least one high level contact surface unit, in which at least two adjacent high level contact surfaces are combined to form a unit. Analogously, the second contact strip can also, additionally or alternatively, contain at least one signal contact surface unit, in which at least two adjacent signal contact surfaces, each with the same voltage level, can be combined to form a unit. With this embodiment, the number of electrical lines for connecting the contact surfaces with the low level and high level connections or the signal connections can be significantly reduced.

The low voltage level and/or the high voltage level can represent a level differing from a supply voltage and/or a ground. As a result, short circuits, e.g., can also be diagnosed on the basis of the ground or supply.

According to another embodiment, each contact surface of the first contact strip can be located opposite a signal contact surface. In particular, the slider can be configured to electrically connect two opposing contact surfaces to generate each of the six signals. As a result, the space requirements for the gear selection apparatus can be further reduced.

It is advantageous when the slider contains a first contact unit comprised of at least three contact elements, at least one second contact unit comprised of at least three further contact elements, and a spacer. The first contact elements and/or the further contact elements can each be configured to electrically connect a contact surface of the first contact strip to a signal contact surface. The spacer can be configured to space the first contact unit apart from the second contact unit such that there are at least three adjacent contact surfaces of the first contact strip and/or at least three adjacent signal contact surfaces between the first contact unit and the second contact unit. As a result, a particularly efficient pairing of the contact surfaces of the two contact strips can be ensured by means of the slider, with the lowest possible number of means.

The spacer can also be configured to maintain a defined spacing between the first contact elements within the first contact unit, and/or the further contact elements within the second contact unit. In particular, the defined spacing can be equal to a spacing between the midpoints of two adjacent contact surfaces on the first contact strip or the second contact strip.

According to another embodiment, the gearshift lever can pivot about a pivotal point. The first contact strip and/or the second contact strip can be curved, at least in sections, along an arc encircling the pivotal point. The gearshift lever can be moved to a first position and a second position, e.g., starting from a middle position, by pivoting it in a first direction, and the gearshift lever can be moved to a third position and a fourth position by pivoting it in a second direction, opposite the first direction. This embodiment results in a space-saving and ergonomic movement between five different gearshift lever positions.

The gearshift lever can have a return mechanism that is configured to move the gearshift lever back to the middle position, starting from the first, second, third, or fourth position. As a result, operating comfort is increased when actuating the gear selection apparatus.

The approach presented herein also relates to a method for shifting a vehicle transmission using a gear selection apparatus according to any of the preceding embodiments, wherein the method comprises one or more of the following steps:

inputting the signal combination; and

outputting a control signal for actuating an actuator for shifting the vehicle transmission based on the signal combination.

The approach presented herein also relates to a control device that is configured to execute, actuate, or implement the steps of any variation of the method presented herein in corresponding devices. The fundamental object of the invention can also be quickly and efficiently achieved through this embodiment variation of the invention in the form of a control device.

For this, the control device can contain at least one computer unit for processing signals or data, at least one memory for storing signals or data, at least one interface to a sensor or an actuator for inputting sensor signals from the sensor or outputting control signals to the actuator and/or at least one communication interface for inputting our outputting data embedded in a communication protocol. The computer unit can be a signal processor, a microcontroller, etc., wherein the memory can be a flash drive, an EPROM, or a magnetic memory. The communication interface can be configured for wireless and/or hardwired data input or output, wherein a communication interface for a hardwired data input or output can input or output these data electrically or optically, e.g., from or to a corresponding data transfer line.

A control device can be an electric device in the present case, which processes signals, and outputs control and/or data signals based thereon. The control device can have a hardware and/or software interface. A hardware interface can be part of a so-called system ASIC, for example, that contains various functions of the control device. The interface can also be composed of an independent integrated circuit, or at least in part of discrete components. A software interface can be a software module present on a microcontroller, in addition to other software modules.

In an advantageous embodiment, the vehicle is controlled by the control device. For this, the control device can access sensor signals, e.g. acceleration, pressure, steering angle, or environment signals. The actuation takes place via actuators such as brake or steering actuators, or a motor control device in the vehicle.

A computer program product or computer program that contains program code that can be stored on a machine readable carrier or memory, such as a semiconductor memory, a hard disk memory, or an optical memory, and is used for executing, implementing, and/or activating the steps of the method according to any of the embodiments described above, in particular when the program product or program is executed on a computer or apparatus, is also advantageous.

In the following description of preferred exemplary embodiments of the present invention, the same or similar reference symbols are used for the elements shown in the figures that have similar functions, wherein the descriptions of these elements shall not be repeated.

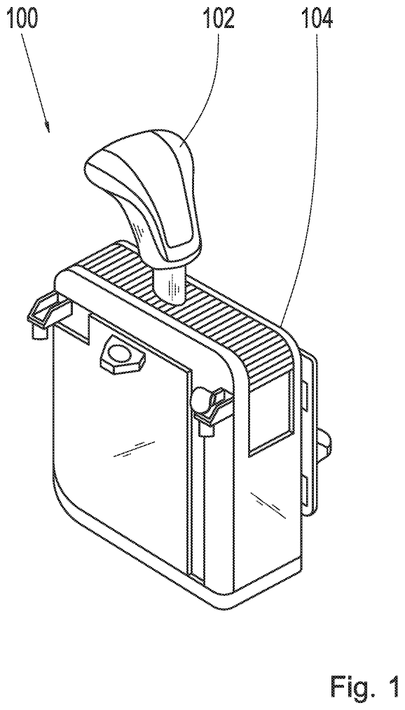

FIG. 1 shows a schematic illustration of a gear selection apparatus 100 according to an exemplary embodiment. A gearshift lever 102 for selecting a position of the gear selection apparatus 100 is shown therein. The gear selection apparatus 100 has a housing 104 enabling a quick and simple installation in a vehicle. The gearshift lever 102 passes through an opening in the housing 104.

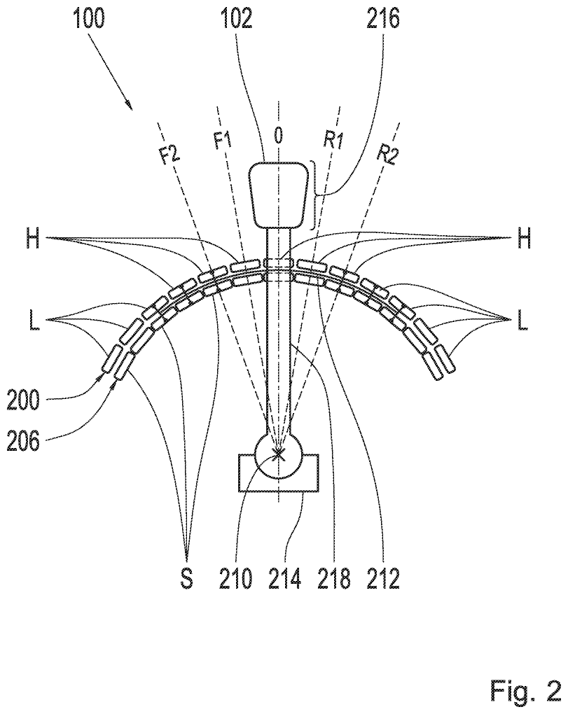

FIG. 2 shows a schematic illustration of a gear selection apparatus 100 according to an exemplary embodiment, this being the gear selection apparatus shown in FIG. 1. The gear selection apparatus 100 comprises a first contact strip 200 comprised of numerous successive low lever contact surfaces L and high level contact surfaces H, also referred to as pads or pad surfaces, wherein the low level contact surfaces L can be subjected to a low voltage level, and the high level contact surfaces H can be subjected to a high voltage level. Moreover, the gear selection apparatus 100 also comprises a second contact strip 206, which in this case is parallel to and below the first contact strip 200, which is formed by numerous signal contact surfaces S. The signal contact surfaces S can be or are each connected to at least six signal connections for tapping a signal combination composed of at least six of the signals representing the low voltage level or the high voltage level.

According to this exemplary embodiment, the two contact strips 200, 206 each have a total of 13 contact surfaces. Alternatively, the contact strips 200, 206 can also be composed of more than 13 contact surfaces. By way of example, the contact strips 200, 206 are arranged in relation to one another such that each contact surface of the first contact strip 200 is paired with a signal contact surface S lying opposite. In addition, the two contact strips 200, 206 are curved along a circular path, the center of which corresponds to a pivotal point 210 of the gearshift lever 102, which in this case is a gearshift lever that can be pivoted between five different positions 0, F1, F2, R1, R2. The gearshift lever 102 is in the middle position 0 in FIG. 2.

There is a slider 212 between the two contact strips 200, 206. The slider 212 is coupled to the gearshift lever 102, and configured to be slid along the two contact strips 200, 206 when the gearshift lever 102 is pivoted about the pivotal point 210 between the five positions, and to electrically connect at least six contact surfaces L, H of the first contact strip 200 with at least six signal contact surfaces S in pairs in each gearshift lever position. As a result, a unique signal combination of at least six signals is generated in each gearshift lever position, which corresponds precisely to the respective gearshift lever position.

According to this embodiment, the slider 212 is configured to electrically connect exactly six contact surfaces L, H of the first contact strip 200 to exactly six signal contact surfaces S in pairs, in each of the five gearshift lever positions, in particular such that the resulting signal combinations are composed of exactly three of the signals representing the low voltage level and three of the signals representing the high voltage level. Individual contacts of the slider 212 are marked with solid points. In combination with a corresponding sequence of the low level contact surfaces L and the high level contact surfaces H, and with a corresponding connection of the signal contact surfaces S to the six signal connections, this has the advantage that the signal combinations each have a Hamming spacing to one another of at least two, by means of which a particularly reliable distinction between gearshift lever positions is obtained. The term Hamming spacing refers to the number of different positions of pairs of signal blocks with a fixed length, in this case pairs of signal combinations, each composed of six signals.

The gearshift lever 102 is designed, e.g., as an intrinsically safe sliding-contact gearshift lever that has a sliding contact serving as the slider 212. By way of example, the gearshift lever 102 is configured to assume a stable middle position 0. The gearshift lever 102 can be pushed forward from the middle position 0 by a driver into two driving modes F1 and F2, and backward into two driving modes R1 and R2. If the driver releases the gearshift lever 102, it automatically returns to the middle position 0. For this, the gearshift lever 102 is coupled to a suitable return mechanism 214, such as a spring mechanism, which is configured to move the gearshift lever 102 back into the middle position 0 from the first position F1, the second position F2, the third position R1, or the fourth position R2, depending on which position has been selected.

The detection of the driver's intention regarding the gearshift lever position by means of sliding contacts has the advantage that the gear selection apparatus 100 requires very little installation space, and is nevertheless extremely reliable. In particular, this makes it possible to obtain a gearshift lever 102 with five set point positions, including a stable middle position that the gearshift lever 102 assumes in the idle state, or to which the gearshift lever 102 returns automatically. To output the signal combinations, the gear selection apparatus 100 contains, e.g., six signal lines, to each of which exactly two voltage levels can be applied. Each gearshift lever position is determined by a unique combination of signals transmitted via these six signal lines. In order to ensure functional reliability according to ISO 26262, the gearshift lever 102 should be appropriately reliable, and able to be diagnosed. In particular, the functional reliability is ensured in that there is a Hamming distance of at least two between the five signal combinations, each comprising two signal levels, assigned to each gearshift lever position. Diagnostic measures can also be implemented therewith.

The gear selection apparatus 100 is in the form of a two-layered printed circuit board, which has, in addition to a connector, a total of four resistors for two voltage dividers. The printed circuit board also has two rows, each containing 13 contact surfaces, which can optionally be located on a circumference defined by a circular movement of a knob 216 of the gearshift lever 102. The one row in the form of the first contact strip 200, the outer row in FIG. 2, provides the two voltage levels; the second contact strip 206, the inner row in FIG. 2, is connected to six signal lines leading outward. The slider 212, attached, e.g., to a knob 216 or rod 218 of the gearshift lever 102, which likewise exhibits a curvature corresponding to the circumference, connects the contact surfaces L, H to which the voltage levels are applied, to the contact surfaces S of the signal lines, depending on the gearshift lever position.

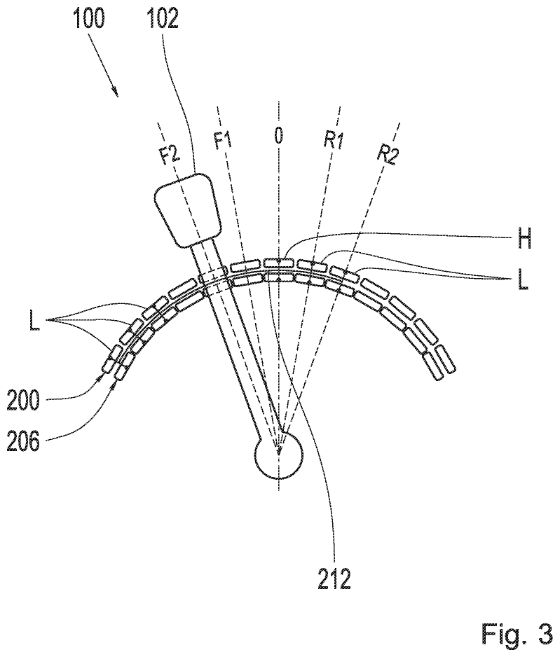

FIG. 3 shows a schematic illustration of the gear selection apparatus 100 shown in FIG. 2. In differing from FIG. 2, the gearshift lever 102 in this case is in the position F2.

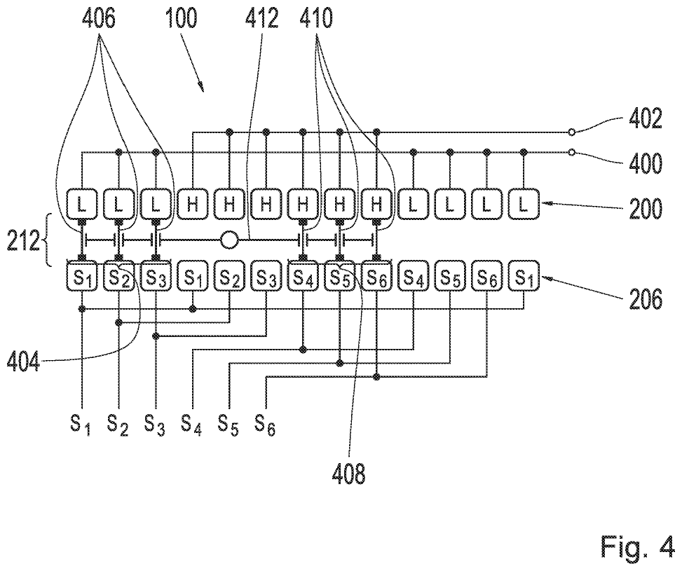

FIG. 4 shows a schematic illustration of an interconnection of contact surfaces L, H, S in a gear selection apparatus 100 according to an exemplary embodiment, e.g. a gear selection apparatus such as that described above in reference to FIGS. 1 to 3. A wiring of the pads L, H of the power supply and the signal lines to the six signal connection S₁, S₂, S₃, S₄, S₅, S₆ via the slider 212, which is in the position F2, is shown therein. It can be seen that the low level contact surfaces L are each electrically connected to a low level connection 400 for the low voltage level, and the high level contact surfaces H are each connected to a high level connection 402 for the high voltage level, via corresponding lines. The signal contact surfaces are likewise connected via corresponding lines to the six signal connections S₁, S₂, S₃, S₄, S₅, S₆. The assignment of the individual signal contact surfaces S to the respective signal connections is indicated at the bottom. As explained above, the contact surfaces L, H and the signal contact surfaces S are arranged in pairs, opposite one another.

The slider 212 according to this exemplary embodiment comprises a first contact unit 404 composed of three contact elements 406, a second contact unit 408 composed of three further contact elements 410, and a spacer 412. The contact elements 406, 410 are configured to electrically connect each contact surface L or H to a signal contact surface S in each gearshift lever position. In the gearshift lever position F2 shown in FIG. 4, the following pairs of contacts are obtained, wherein the sequence of the letters corresponds to a sequence of adjacent contact surfaces in the respective contact strips 200, 206:

| | | | | | | | | | | | | |
|---|---|---|---|---|---|---|---|---|---|---|---|---|
| L | L | L | (H | H | H) | H | H | H | (L | L | L | L) |
| S₁ | S₂ | S₃ | (S₁ | S₂ | S₃) | S₄ | S₅ | S₆ | (S₄ | S₅ | S₆ | S₁) |

The letters in parentheses represent contact pairs that are disconnected in the position F2, i.e. the slider 212 does not produce an electrical connection between them. According to this exemplary embodiment, the spacer 412 is configured to space the first contact unit 404 apart from the second contact unit 408, such that there are three adjacent contact surfaces L or H of the first contact strip 200 and three adjacent signal contact surfaces S between the first contact unit 404 and the second contact unit 408 in each gearshift lever position, such that in F2, by way of example, there are three high level contact surfaces H and three signal contact surfaces S₁, S₂, and S₃ therebetween.

The connection configuration of the pads is numerically optimized in order to satisfy safety requirements. The result of such an optimization is shown in FIG. 4. The configuration shown in FIG. 4 is regarded as particularly simple and reliable.

If the power supply in the form of the first contact strip is connected to the high and low level connections 400, 402, and the signal lines are connected to the signal connections S₁, S₂, S₃, S₄, S₅, S₆, then the low level signals L representing the low voltage level and the high level signals H representing the high voltage levels are generated at the signal connections S₁, S₂, S₃, S₄, S₅, S₆, such that the following requirements are satisfied:
a Hamming spacing of two from each valid signal to any other valid signal;
each signal comprises three high level signals H and three low level signals L.

For purposes of simplicity, the high and low level signals are indicated here with the same letters as the contact surfaces of the first contact strip 200 connected to the corresponding high and low level connections.

FIGS. 5 to 9 show how the signal combinations are composed of the various levels of the power supply at the signal connections S₁, S₂, S₃, S₄, S₅, S₆ for all gearshift lever positions when the circuitry is configured like that in FIG. 4.

FIG. 5 shows a schematic illustration of the electrical connections in the gear selecting apparatus 100 shown in FIG. 4, in the gearshift lever position F2 (“forward two”). A signal combination of six signals LLLHHH is then output at the signal connections S₁, S₂, S₃, S₄, S₅, S₆.

FIG. 6 shows a schematic illustration of the electrical connections in the gear selection apparatus 100 shown in FIG. 4, in the gearshift lever position F1 (“forward 1”). A signal combination of six signals HLLLHH is then output at the signal connections S₁, S₂, S₃, S₄, S₅, S₆.

FIG. 7 shows a schematic illustration of the electrical connections in the gear selection apparatus 100 shown in FIG. 4, in the gearshift lever position 0, which corresponds to a middle position of the gearshift lever. A signal combination of six signals HHLLLH is then output at the signal connections S₁, S₂, S₃, S₄, S₅, S₆.

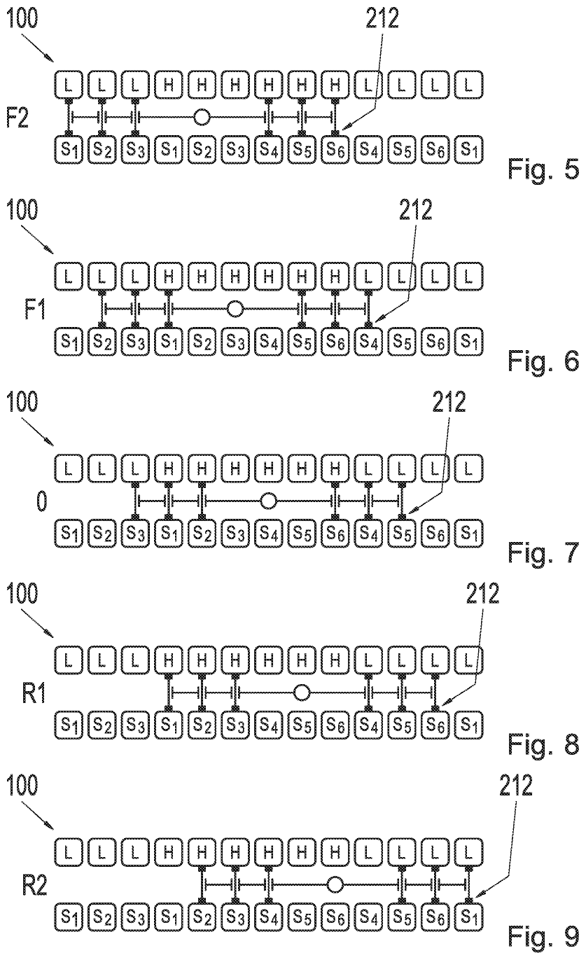

FIG. 8 shows a schematic illustration of the electrical connections in the gear selection apparatus 100 shown in FIG. 4, in the gearshift lever position R1 (“rear one”). A signal combination of six signals HHHLLL is then output at the signals connections S₁, S₂, S₃, S₄, S₅, S₆.

FIG. 9 shows a schematic illustration of the electrical connections in the gear selection apparatus 100 shown in FIG. 4, in the gearshift lever position R2 (“rear 2”). A signal combination of six signals LHHHLL is then output at the signal connections S₁, S₂, S₃, S₄, S₅, S₆.

The total number of contact surfaces in each contact strip should be at least 13, if five gearshift lever positions are to be evaluated and a Hamming spacing of two is required between the signals. The circuitry of the second contact strip 206 shown in FIG. 3 has likewise proven to be optimal for geometrical reasons.

When the circuitry of the signal contact surfaces S is in the sequence S₁ S₂ S₃ S₁ S₂ S₃ S₄ S₅ S₆ S₄ S₅ S₆ S₁, the interconnection of the contact surfaces H, L, i.e. the pad sequence of the power supply can be seen for each exemplary embodiment in the following table:

| | Signals on S₁ to S₆ depending on the gearshift lever position | | | | |
|---|---|---|---|---|---|
| Pad circuitry | F2 | F1 | 0 | R1 | R2 |
| LLLHHHHHHLLLL | LLLHHH | HLLLHH | HHLLLH | HHHLLL | LHHHLL |
| LLHHHLHHLLLHL | LLHHHL | HLHLHL | HHHLLL | HHLLLH | LHLHLH |
| LHLHLHHLHLHLL | LHLHLH | HHLLLH | HLLLHH | HLHLHL | LLHHHL |
| LHHHLLHLLLHHL | LHHHLL | HHHLLL | HLHLHL | HLLLHH | LLLHHH |
| HLLLHHLHHHLLH | HLLLHH | LLLHHH | LHLHLH | LHHHLL | HHHLLL |
| HLHLHLLHLHLHH | HLHLHL | LLHHHL | LHHHLL | LHLHLH | HHLLLH |
| HHLLLHLLHHHLH | HHLLLH | LHLHLH | LLLHHH | LLHHHL | HLHLHL |
| HHHLLLLLLHHHH | HHHLLL | LHHHLL | LLHHHL | LLLHHH | HLLLHH |

The first pad circuitry corresponds to the interconnections shown in FIG. 4. The remaining combinations require a change in the interconnections of the power supply such that the voltage levels are in the sequences shown in the column “pad circuitry.” The outputting of the signals a the signal connections S₁, S₂, S₃, S₄, S₅, S₆ for the five gearshift lever positions is shown in the columns “F2,” “F1,” “0,” “R1,” “R2” in the table.

The pads are thus laid out in two rows, wherein the one row is connected to the supply lines, and the other row is connected to the signal lines. In particular, the interconnection or configuration of the slider is such that there is a Hamming spacing of at least two between all of the possible signal combinations, comprising a total of at least six signals L, H. In addition, all of the signal combinations each have the same number of high level signals H and low level signals L, such that a further criterion for checking signal plausibility is obtained.

According to one exemplary embodiment, adjacent contact surfaces of the first contact strip, each of which are assigned the same voltage level, are connected to a pad surface. Likewise, adjacent signal contact surfaces of the second contact strip, each of which are assigned the same voltage level, are connected to a pad surface. As a result, the total number of electric lines necessary for the circuitry of the gear selection apparatus can be reduced.

According to one exemplary embodiment, voltage levels are used for H and L that differ from the supply voltage or ground potential of the gear selection apparatus, such that a diagnosis can take place here, such as the detection of short circuits on the basis of the ground or supply voltage.

The approach presented herein can also be used in conjunction with circuits with more than five set point gearshift lever positions and a Hamming spacing of more than three. In this regard, the gear selection apparatus described above in reference to FIGS. 2 to 9 is to be regarded as just one of numerous possible exemplary embodiments of the approach presented herein.

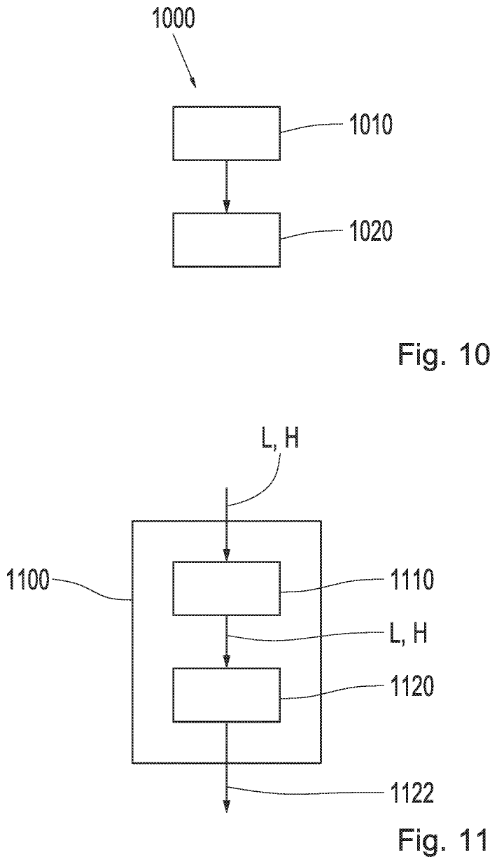

FIG. 10 shows a flow chart for a method 1000 according to an exemplary embodiment. The method 1000 for shifting a vehicle transmission can be executed using a gear selection apparatus such as that described above in reference to FIGS. 1 to 9. The signal combination comprising the high and low level signals is input in step 1010. An actuation signal for actuating an actuator for shifting the vehicle transmission is output in a second step 1020 based on the signal combination.

FIG. 11 shows a schematic illustration of a control device 1100 according to an exemplary embodiment. The control device 1100 can be used, e.g., for executing the method described above in reference to FIG. 10. The control device 1100 comprises an input unit 1110 for inputting the various signal combinations comprising the signals H and L, and an output unit 1120 for outputting the actuation signal 1122 based on the signal combination.

The exemplary embodiments described herein and shown in the figures are selected merely by way of example. Different exemplary embodiments can be combined with one another, either in their entirety, or with respect to individual features. An exemplary embodiment can also be supplemented by features of another exemplary embodiment. Furthermore, method steps according to the invention can be repeated or executed in a sequence other than that described herein.

If an exemplary embodiment comprises an “and/or” conjunction between a first feature and a second feature, this can be read to mean that the exemplary embodiment according to a first embodiment comprises both the first feature and the second feature, and according to another embodiment, comprises either just the first feature or just the second feature.

### REFERENCE SYMBOLS

0 middle gearshift lever position
F1 first gearshift lever position
F2 second gearshift lever position
H high level contact surface; high level signal
L low level contact surface; low level signal
R1 third gearshift lever position
R2 fourth gearshift lever position
S signal contact surface
S₁ first signal connection; signal contact surface connected to the first signal connection
S₂ second signal connection; signal contact surface connected to the second signal connection
S₃ third signal connection; signal contact surface connected to the third signal connection
S₄ fourth signal connection; signal contact surface connected to the fourth signal connection
S₅ fifth signal connection; signal contact surface connected to the fifth signal connection
S₆ sixth signal connection; signal contact surface connected to the sixth signal connection
100 gear selection apparatus
102 gearshift lever
104 housing
200 first contact strip
206 second contact strip
210 pivotal point
212 slider
214 return device
216 knob
218 rod
400 low level connection
402 high level connection
404 contact unit
406 contact element
408 second contact unit
410 second contact element
412 spacer
1000 method for shifting a vehicle transmission
1010 input step
1020 output step
1100 control device
1110 input unit
1120 output unit
1122 actuation signal

1. A gear selection apparatus for a vehicle, wherein the gear selection apparatus comprises:
a first contact strip comprising numerous a plurality of low level contact surfaces and a plurality of high level contact surfaces, wherein the low level contact surfaces are configured to connect to a low level connection for applying a low voltage level, and wherein the high level contact surfaces are configured to connect to a high level connection for applying a high voltage level;
a second contact strip comprising a plurality of signal contact surfaces, wherein the signal contact surfaces are configured to connect to at least six signal connections for tapping a signal combination comprised of at least six signals representing at least one of the low voltage levels and the high voltage levels; and
a gearshift lever with a slider, wherein the slider is configured to slide along the first contact strip and the second contact strip between a plurality of gearshift lever positions when the gearshift lever is actuated, wherein the slider is configured to electrically connect each of the contact surfaces of the first contact strip to respective signal contact surfaces for generating each of the at least six signals in each of the gearshift lever positions of the plurality of gearshift positions.

2. The gear selecting apparatus according to claim 1, wherein the slider is configured to connect at least one of the low level contact surfaces and the high level contact surfaces to the signal contact surfaces such that at least three of the low level signals represent the low voltage level, and such that at least three of the high level signals represent the high voltage level.

3. The gear selection apparatus according to claim 1, wherein a total number of the low level contact surfaces and the high level contact surfaces is the same as the total number of signal contact surfaces.

4. The gear selection apparatus according to claim 1, wherein the first contact strip has a total of at least 13 low level contact surfaces and high level contact surfaces, and wherein the second contact strip has a total of at least 13 signal contact surfaces.

5. The gear selection apparatus according to claim 4, wherein the low level contact surfaces, hereinafter indicated with the letter “L,” and the high level contact surfaces, hereinafter indicated with the letter “H,” are arranged in one of the following sequences:
LLLHHHHHHLLLL,
LLHHHLHHLLLHL,
LHLHLHHLHLHLL,
LHHHLLHLLLHHL,
HLLLHHLHHHLLH,
HLHLHLLHLHLHH,
HHLLLHLLHHHLH,
HHHLLLLLLHHHH.

6. The gear selection apparatus according to claim 1, wherein the first contact strip has at least one low level contact surface unit, wherein at least two adjacent low level contact surfaces are combined to form a surface unit wherein at least two adjacent high level contact surfaces are combined to form a surface unit, and wherein at least two adjacent signals contact surfaces, each assigned to the same voltage level, are combined to form a surface unit.

7. The gear selection apparatus according to claim 1, wherein at least one of the low voltage level and the high voltage level represents a level other than that of at least one of the supply voltage and a ground.

8. The gear selection apparatus according to claim 1, in which wherein at least one signal contact surface is located opposite each contact surface of the first contact strip, and wherein the slider is configured to electrically connect two opposing contact surfaces for generating each of the six signals.

9. The gear selection apparatus according to claim 1,
wherein the slider comprises a first contact unit comprised of at least three first contact elements,
wherein the slider comprises at least one second contact unit comprised of at least three further contact elements, and
wherein the slider comprises a spacer,
wherein at least one of the first contact elements and the further contact elements are configured to electrically connect each contact surface of the first contact strip to a signal contact surface, and
wherein the spacer is configured to space the first contact unit apart from the second contact unit such that there are at least three adjacent contact surfaces of the first contact strip located between the first contact unit and the second contact unit.

10. The gear selection apparatus according to claim 1,
wherein the gearshift lever is configured to be pivoted about a pivot point,
wherein at least one of the first contact strip and the second contact strip is at least partially curved along a circular path encircling the pivot point, and
wherein the gearshift lever is movable to a first gearshift lever position and a second gearshift lever position by pivoting in a first direction starting from a middle gearshift lever position, and
wherein the gearshift lever is movable to a third gearshift lever position and a fourth gearshift lever position by pivoting in a second direction, the second direction being opposite the first direction.

11. The gear selection apparatus according to claim 10, further comprising a return device that is configured to return the gearshift lever to the middle position when the gearshift lever is located in at least one of the first gearshift lever position, the second gearshift lever position, the third gearshift lever position, and the fourth gearshift lever position.

12. A method for shifting a vehicle transmission using the gear selection apparatus according to claim 1, wherein the method comprises the following steps:
inputting the signal combination; and
outputting an actuation signal for actuating an actuator for shifting the vehicle transmission based on the signal combination.

13. (canceled)

14. (canceled)

15. A machine-readable memory on which computer program is stored, the computer program being configured to execute the method of claim 12.

16. The gear selection apparatus according to claim 4, wherein the signal contact surfaces are arranged in the following sequence, adjacent to one another:
S1 S2 S3 S1 S2 S3 S4 S5 S6 S4 S5 S6 S1,
wherein S1 represents a signal contact surface connected to a first signal connection, wherein S2 represents a signal contact surface connected to a second contact signal connection, wherein S3 represents a signal contact surface connected to a third contact signal connection, wherein S4 represents a signal contact surface connected to a fourth signal connection, wherein S5 represents a signal contact surface connected to a fifth signal connection, and wherein S6 represents a signal contact surface connected to a sixth signal connection.
